(19) United States
(12) Patent Application Publication
(10) Pub. No.: US 2010/0321136 A1
(43) Pub. Date: Dec. 23, 2010

(54) WAVEGUIDE TRANSITION ARRAGEMENT

(76) Inventors: Per Ligander, Goteborg (SE); Marcus Karl Hasselblad, Molndal (SE)

Correspondence Address: ERICSSON INC., 6300 LEGACY DRIVE, M/S EVR 1-C-11, PLANO, TX, 75024, US

(21) Appl. No.: 12/810,051

(22) PCT Filed: Dec. 20, 2007
(86) PCT No.: PCT/SE2007/001152

§ 371 Date: Jun. 22, 2010

(51) Int. Cl. H01P 1/04

(52) U.S. Cl. 333/254

(57) ABSTRACT

The present invention relates to a transition arrangement comprising a first surface-mountable waveguide part (4) and a second surface-mountable waveguide part (5), each waveguide part (4, 5) comprising a first wall (7, 10), a second wall (8, 11) and a third wall (9, 12), which second and third walls (8, 9; 11, 12) are arranged to contact a dielectric carrier material (1), all the walls (7, 8, 9; 10, 11, 12) together essentially forming a U-shape, where the surface-mountable waveguide parts (4, 5) are arranged to be mounted on the dielectric carrier material (1) in such a way that the surface-mounted waveguide parts (4, 5) comprise ends (4a, 5a) which are positioned to face each other. The transition arrangement further comprises an electrically conducting sealing frame (17) that is arranged to be mounted over the ends (4a, 5a), covering them, where the frame (17) has a first wall (18), a second wall (19) and a third wall (20), where the second and third walls (19, 20) are arranged to contact the dielectric carrier material (1), all the walls together essentially forming a U-shape.

### TECHNICAL FIELD

The present invention relates to a transition arrangement comprising a first surface-mountable waveguide part and a second surface-mountable waveguide part, the first waveguide part comprising a first wall, a second wall and a third wall, which second and third walls are arranged to contact a dielectric carrier material, all the walls together essentially forming a U-shape, the second waveguide part comprising a first wall, a second wall, and a third wall, which second and third walls are arranged to contact the dielectric carrier material, all the walls together essentially forming a U-shape, where the surface-mountable waveguide parts are arranged to be mounted on the dielectric carrier material in such a way that the surface-mounted waveguide parts comprise ends which are positioned to face each other.

The present invention also relates to an electrically conducting sealing frame.

### BACKGROUND

When designing microwave circuits, transmission lines and waveguides are commonly used. A transmission line is normally formed on a dielectric carrier material. Due to losses in the dielectric carrier material, it is sometimes not possible to use any transmission lines. When there for example is a diplexer in the layout, the diplexer may have to be realized in waveguide technology. Waveguides are normally filled with air or other low-loss materials.

Waveguide diplexers used today are large mechanical components screwed into a mechanical cabinet and connected to different parts such as for example an antenna via some type of waveguide flange. It is desirable to mount such a diplexer structure on a dielectric carrier material, such that it forms a surface-mounted waveguide structure.

Such a surface-mounted waveguide is normally made having three walls and one open side. Metalization is then provided on the side of the dielectric carrier material facing the waveguide, where the metalization serves as the remaining wall of the waveguide, thus closing the waveguide structure when the waveguide is fitted to the dielectric carrier material.

An example of surface-mountable waveguides is disclosed in the paper “Surface-mountable metalized plastic waveguide filter suitable for high volume production” by Thomas J Müller, Wilfried Grabherr, and Bemd Adelseck, 33^{rd} European Microwave Conference, Munich 2003. Here, a surface-mountable waveguide is arranged to be mounted on a so-called footprint on a circuit board. A microstrip conductor to waveguide transition is disclosed, where the end of the microstrip conductor acts as a probe for feeding the waveguide's opening.

Surface mounting of large mechanical components, such as diplexers, may result in mechanical stress problems due to different coefficients of thermal expansion, CTE, of the materials involved, such as for example so-called twist and bow. Furthermore, such a large surface-mounted structure as a diplexer is too large to handle in an automated production line.

One way to solve this problem is to split the diplexer into a number of smaller parts. These parts have to be sufficiently connected to each other in order to present a proper electrical function. This problem is apparent for all large surface-mounted waveguide structures.

An example of a solution according to prior art is disclosed in prior art FIG. 1, showing a simplified cross-sectional side-view. A first surface-mounted waveguide part P1 and a second surface-mounted waveguide part P2 are mounted on a dielectric carrier material P3. The ends of these surface-mounted waveguide parts that face each other comprise respective 90° bends P4, P5, changing the direction of the transmitted signals 90° such that they are directed through corresponding openings P6, P7 in the dielectric carrier material P3. On the other side of the dielectric carrier material, a third surface-mounted waveguide part P8 is mounted, the third surface-mounted waveguide part comprising two 90° bends P9, P10 positioned such that the signal directed through the openings P6, P7 is guided through the third surface-mounted waveguide P8 part in such a way that it functions as a link between the first surface-mounted waveguide part P1 and the second surface-mounted waveguide part P2. The details of the bends P4, P5; P9, P10 are not shown in FIG. 1, only the function is schematically indicated.

This solution is, however, rather complicated and requires that a special waveguide part, having two 90° bends, is mounted on the other side of the dielectric carrier, material, and that all waveguide parts are aligned with the openings such that there is no interruption in the transmission of the signals.

### SUMMARY

The object of the present invention is to provide a waveguide transition arrangement between different surface-mounted waveguide structure parts which are to be sufficiently electrically connected to each other in order to present a proper electrical function.

This problem is solved by means of a waveguide arrangement as mentioned initially. Said arrangement further comprises an electrically conducting sealing frame that is arranged to be mounted over the ends, covering them, where the sealing frame has a first wall, a second wall and a third wall, where the second and third walls are arranged to contact the dielectric carrier material, all the walls together essentially forming a U-shape.

This problem is also solved by means of an electrically conducting sealing frame according to the above.

According to a preferred embodiment, there is a junction gap between the ends, where the sealing frame is arranged to seal the junction gap, such that the transition properties for a signal that is transferred between the mounted waveguide parts are enhanced.

According to another preferred embodiment, the waveguide parts each have a respective longitudinally extending flange part comprised in each of the second walls and third walls, and that the sealing frame has a respective longitudinally extending flange part, each having a length, the flange parts being comprised in each of the second and third walls, all the flange parts being arranged to be the parts of said walls which contact the dielectric carrier material when the waveguide parts and the sealing frame are mounted to it.

According to another preferred embodiment, the flange parts of the waveguide parts do not extend to the two said ends of the waveguide parts, such that a first distance between the ends of opposing flange parts of the second walls of the waveguide parts and a second distance between the ends of opposing flange parts of the third walls of the waveguide parts both exceed the length of each one of the sealing frame's flanges, such that the sealing frame's flanges may be fitted between the respective flanges of the waveguide parts.

According to another preferred embodiment, the sealing frame is made in several layers of material; an outer layer being made of an electrically insulating material, a middle layer constituting a metalization layer, making the sealing frame electrically conductive, an inner layer comprising an electrically conducting attachment means in the form of a solder alloy or electrically conducting glue.

According to another preferred embodiment, in a part of the first waveguide part which is arranged to be covered by the sealing frame, a first recess is formed, running perpendicular to the longitudinal extension of the first waveguide part, all the way along the three walls, where a corresponding second recess is formed on the second waveguide part, and where, corresponding to these recesses, lines of an electrically conducting attachment means are dispensed on the sides of the walls of the sealing frame that are intended to face the waveguide parts, such that the lines of electrically conducting attachment means are fitted into the recesses when the sealing frame is mounted.

Other preferred embodiments are evident from the dependent claims.

A number of advantages are provided by the present invention. For example:
the sealing arrangement is simple and of low cost;
a connection of two surface-mounted waveguide parts is achieved without disturbance of the waveguide mode of a propagating signal;
two surface-mounted waveguide parts are connected in a loss-less manner;
two surface-mounted waveguide parts are connected in a flexible manner, providing a relaxed relation between the waveguide parts due to the ductile behavior of the sealing frame;
two surface-mounted waveguide parts are connected without any risk of leakage;
the present invention can be assembled using a pick-and-place machine; and
two surface-mounted waveguide parts are connected using no extra area on the dielectric material on which they are mounted.

### BRIEF DESCRIPTION OF THE DRAWINGS

The present invention will now be described more in detail with reference to the appended drawings, where:

FIG. 1 is a sectional side-view of a prior art configuration;

FIG. 2a is a top view of two surface-mounted waveguide parts;

FIG. 2b is a side view of two surface-mounted waveguide parts;

FIG. 2c is an end view of a surface-mountable waveguide parts;

FIG. 3a is a top view of a sealing frame according to the present invention;

FIG. 3b is an end view of a sealing frame according to the present invention;

FIG. 4a is a side view of a sealing frame according to the present invention being mounted to two surface-mounted waveguide parts;

FIG. 4b is a sectional view of a section in FIG. 4a;

FIG. 5 is a detailed view of a part of the sealing frame, illustrating a preferred embodiment; and

FIG. 6 is an exploded perspective view of two surface-mountable waveguide parts and a sealing frame according to the present invention.

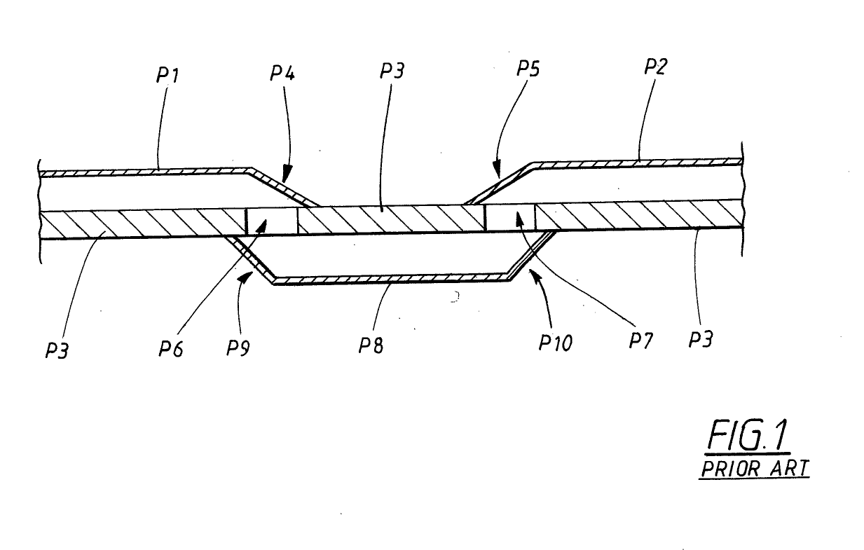

### DETAILED DESCRIPTION

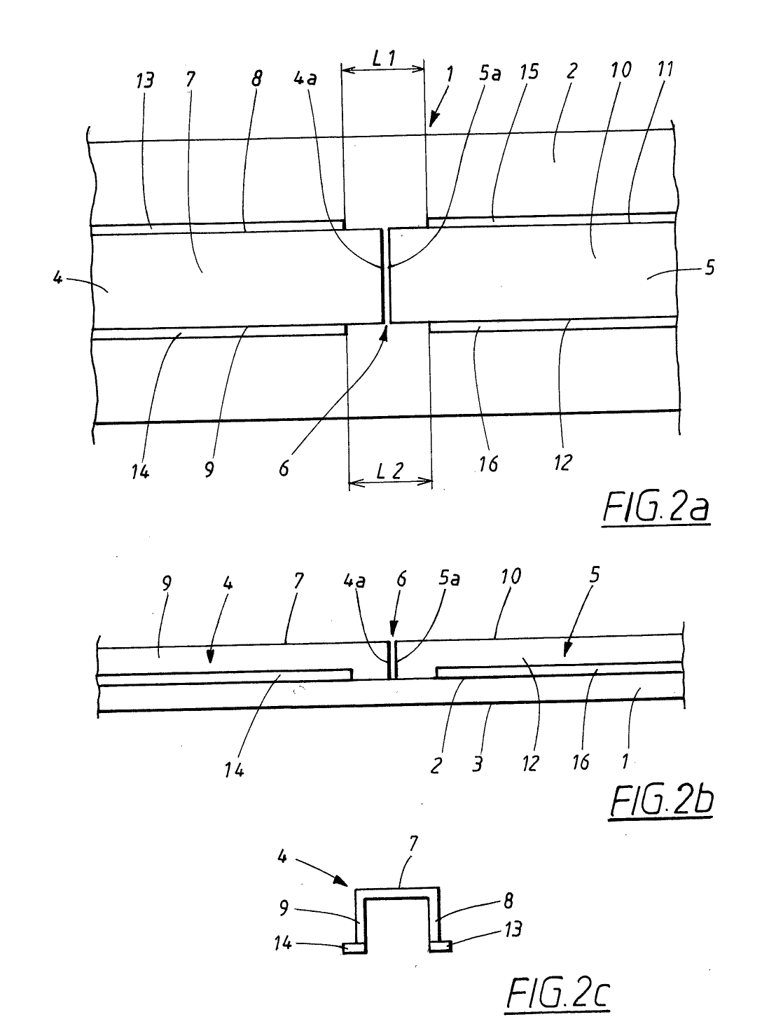

In FIG. 2a and FIG. 2b, showing a respective top view and side view of a first embodiment example of the present invention, a dielectric carrier material 1 is shown, having a first main side 2 and a second main side 3, originally having a metallic cladding on both sides. The metallic cladding is typically comprised of a layer of copper, which optionally is covered with thin layers of other metals to enhance the electrical, mechanical, and chemical properties of the cladding. The metal on the second main side 3 is used as a ground plane, and the metal on the first main side 2 is etched away to such an extent that desired metal patterns are formed on the first main side 2. A first surface-mounted waveguide part 4 and a second surface-mounted waveguide part 5 are mounted on the dielectric carrier material 1. Those respective ends 4a, 5a of these surface-mounted waveguide parts that face each other are positioned relatively close to each other, preferably as close as possible, minimizing a junction gap 6 between the waveguide parts 4, 5.

Each waveguide part 4, 5 has three respective walls 7, 8, 9; 10, 11, 12 and one open side, arranged to face the dielectric material 1. Metalization is provided on the side of the dielectric carrier material 1 facing the waveguide parts 4, 5, where the metalization serves as the remaining wall of the waveguide parts 4, 5, thus closing the waveguide part 4, 5 when mounted onto the dielectric carrier material.

Regarding the first waveguide part 4, also with reference to FIG. 2c, a first wall 7 is arranged to be parallel to the dielectric carrier material 1 when the first waveguide part 4 is mounted onto it, and then held at a distance from said material by means of a second wall 8 and third wall 9, which second and third walls 8, 9 are arranged to contact the dielectric carrier material 1, all the walls 7, 8, 9 together essentially forming a U-shape when regarding the first waveguide part 4 from its short end. The second waveguide part 5 has the same configuration of its walls 10, 11, 12.

The waveguide parts 4, 5 are mounted in a known way, each having a longitudinally extending flange part 13, 14; 15, 16 comprised in each of the second walls 8, 11 and third walls 9, 12, the flanges 13, 14; 15, 16 being arranged to be the parts of these walls 8, 11; 9, 12 which contact the dielectric carrier material 1 when the waveguide parts 4, 5 are mounted to it. The flanges 13, 14; 15, 16 are soldered, or glued by means of electrically conducting glue, to a corresponding so-called footprint of metal on the dielectric material's first main side 2.

As indicated above, there is, however, always a junction gap 6 between the waveguide parts 4, 5. At the junction gap 6, the currents running between the waveguide parts 4, 5 experience a discontinuity, and there is possibly also undesired leakage at the junction gap 6.

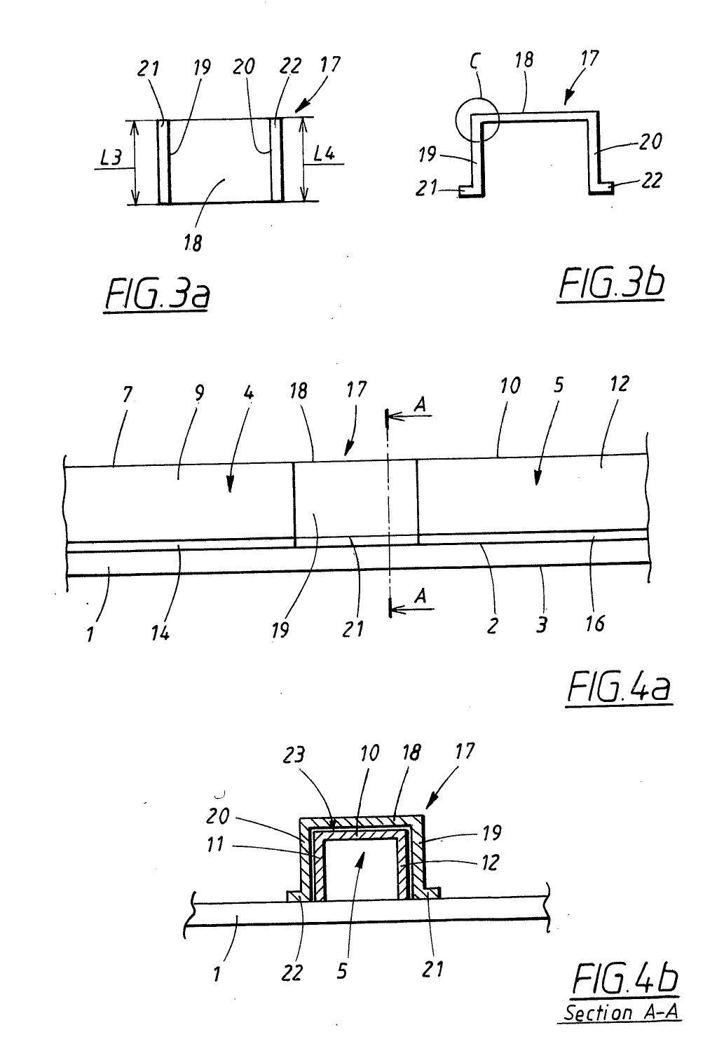

According to the present invention, with reference to FIG. 3a, FIG. 3b and FIG. 4a, an electrically conducting sealing frame 17 is arranged to be mounted over the junction gap 6. The sealing frame 17 has a first wall 18, a second wall 19 and a third wall 20, where the first wall 18 is arranged to be parallel to the dielectric carrier material 1 when it is mounted to it, and then held at a distance from said material 1 by means of the second wall 19 and the third wall 20, which second and third walls 19, 20 are arranged to contact the dielectric carrier material 1, all the walls together essentially forming a U-shape when regarding the sealing frame 17 from its short end.

The sealing frame 17 has a respective longitudinally extending flange part 21, 22 comprised in each of the second wall 19 and third wall 20, each having a length L3, L4, the flanges 21, 22 being arranged to be the parts of these walls which contact the dielectric carrier material 1 when the sealing frame 17 is mounted to it. The lengths L3, L4 of the flanges 21, 22 are preferably essentially equal.

The sealing frame 17 has such dimensions that it is possible to fit it over the waveguide parts, i.e. the inner dimensions of the sealing frame 17 are equal to, or greater than, the outer dimensions of the waveguide parts 4, 5. The sealing frame's thickness is not of importance. However, it should preferably be rigid enough to be handled, for example by a human or by a pick-and-place machine.

As can be seen in FIG. 2a and FIG. 2b, the flanges 13, 14; 15, 16 of the waveguide parts 4, 5 do not extend to the ends 4a, 5a of the waveguide parts that face each other, such that a first distance L1 between the ends of opposing flanges 13, 15 of the second walls 8, 11 of the waveguide parts 4, 5 and a second distance L2 between the ends of opposing flanges 14, 16 of the third walls 9, 12 of the waveguide parts 4, 5 both exceed the length L3, L4 of each one of the sealing frame's flanges 21, 22, such that the sealing frame's flanges 21, 22 may be fitted between the respective flanges 14, 16; 13, 15 of the waveguide parts 4, 5. Preferably, the distances L1 and L2 between the ends of opposing flanges 14, 16; 13, 15 of the waveguide parts 4, 5 are positioned essentially opposite each other with reference to the waveguide parts' longitudinal extension.

With reference to FIG. 4a and FIG. 4b, when mounted, the sealing frame 17 is fitted over the junction gap 6 between the waveguide parts 4, 5, sealing it. The sealing frame 17 is then soldered to the waveguide parts 4, 5. It is also conceivable that electrically conducting glue is used. The solder or glue is indicated with the reference number 23.

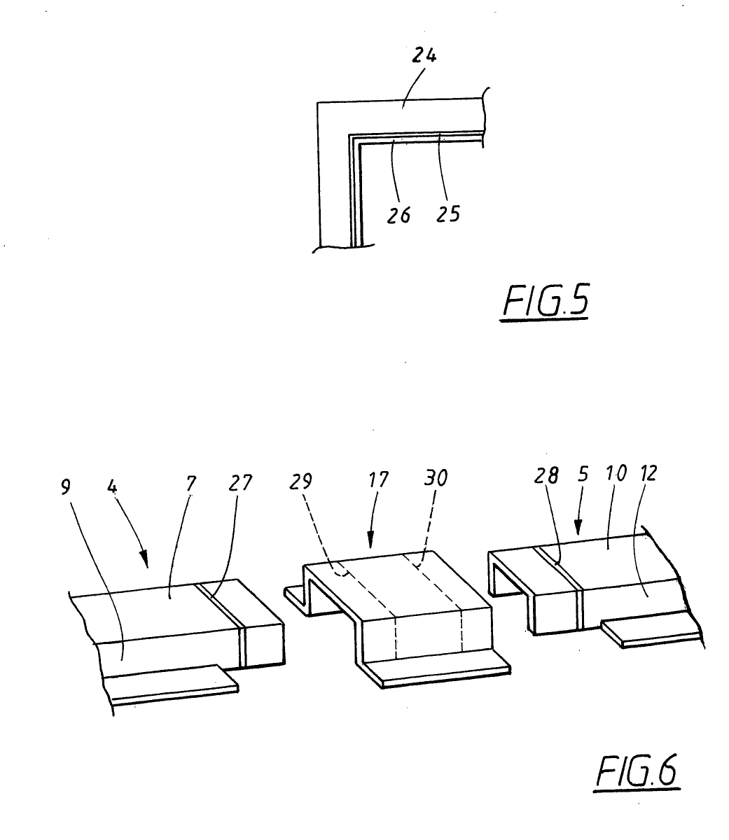

According to a preferred embodiment, with reference to FIG. 5, showing the part of the sealing frame 17 indicated by a circle C in FIG. 3b, the sealing frame 17 is made in several layers of material. The outer layer 24 is made of a ductile layer, having electrically insulating properties, for example a polymer or a ceramic material such as LTCC (Low Temperature Co-fired Ceramic). Inside the outer layer there is a metalization layer 25, making the sealing frame electrically conductive. The metalization layer 25 is in turn covered by a soft solder alloy 26 with an appropriate thickness, for example about 150 μm. The soft solder alloy 26 may be exchanged with any appropriate electrically conducting attachment means, such as electrically conducting glue. It is also conceivable to use any other type of solder alloy depending on the properties of the materials actually used.

According to another preferred embodiment, with reference to FIG. 6, showing an exploded perspective view of the first waveguide part 4, the second waveguide part 5 and the sealing frame 17 positioned slightly apart from each other due to the exploded view, at the part of the first waveguide part 4 which is arranged to be covered by the sealing frame 17, a first recess 27 is formed. The first recess 27 runs perpendicular to the longitudinal extension of the first waveguide part 4, all the way along the three walls 7, 8, 9. A corresponding second recess 28 is formed on the second waveguide part 5.

Corresponding to these recesses 27, 28, lines of solder compound 29, 30 are dispensed on the sides of the walls 18, 19, 20 of the sealing frame 17 that are intended to face the waveguide parts, such that the lines of solder 29, 30 are fitted into the recesses 27, 28 when the sealing frame 17 is mounted. It is possible to combine the lines of solder 29, 30 with indents in the sealing frame 17, the indents being intended to fit into the recesses 27, 28 when the sealing frame 17 is mounted. The solder may be exchanged with any appropriate electrically conducting attachment means, such as electrically conducting glue.

The present invention is not limited to the embodiment examples according to the above, but may vary freely within the scope of the appended claims.

For example, the metal used may be any suitable conducting material, for example copper, silver, or gold. The metallic claddings may be deposited onto the dielectric material by various methods, for example printing, plating, or rolling.

The dielectric material may comprise several layers if necessary, the layers comprising different types of circuitry. Such a layered structure may also be necessary for mechanical reasons.

The flanges may be of any suitable form, generally forming flange parts.

1. A transition arrangement comprising a first surface-mountable waveguide part (4) and a second surface-mountable waveguide part (5), the first waveguide part (4) comprising a first wall (7), a second wall (8), and a third wall (9), which second and third walls (8, 9) are arranged to contact a dielectric carrier material (1), all the walls (7, 8, 9) together essentially forming a U-shape, the second waveguide part (5) comprising a first wall (10), a second wall (11) and a third wall (12), which second and third walls (11, 12) are arranged to contact the dielectric carrier material (1), all the walls (10, 11, 12) together essentially forming a U-shape, where the surface-mountable waveguide parts (4, 5) are arranged to be mounted on the dielectric carrier material (1) in such a way that the surface-mounted waveguide parts (4, 5) comprise ends (4a, 5a) which are positioned to face each other, characterized in that the transition arrangement further comprises an electrically conducting sealing frame (17) that is arranged to be mounted over the ends (4a, 5a), covering them, where the sealing frame (17) has a first wall (18), a second wall (19) and a third wall (20), where the second and third walls (19, 20) are arranged to contact the dielectric carrier material (1), all the walls together essentially forming a U-shape.

2. A transition arrangement according to claim 1, characterized in that there is a junction gap (6) between the ends (4a, 5a), where the sealing frame (17) is arranged to seal the junction gap (6), such that the transition properties for a signal that is transferred between the mounted waveguide parts (4, 5) are enhanced.

3. A transition arrangement according to claim 1, characterized in that the waveguide parts (4, 5) each have a respective longitudinally extending flange part (13, 14; 15, 16) comprised in each of the second walls (8, 11) and third walls (9, 12), and that the sealing frame (17) has a respective longitudinally extending flange part (21, 22), each having a length (L3, L4), the flange parts (21, 22) being comprised in each of the second wall (19) and third wall (20), all the flange parts (13, 14; 15, 16; 21, 22) being arranged to be the parts of said walls (8, 11; 9, 12; 19, 20) which contact the dielectric carrier material (1) when the waveguide parts (4, 5) and the sealing frame (17) are mounted onto it.

4. A transition arrangement according to claim 3, characterized in that the flange parts (13, 14; 15, 16) of the waveguide parts (4, 5) do not extend to the two said ends (4a, 5a) of the waveguide parts (4, 5), such that a first distance (L1) between the ends of opposing flange parts (13, 15) of the second walls (8, 11) of the waveguide parts (4, 5) and a second distance (L2) between the ends of opposing flange parts (14, 16) of the third walls (9, 12) of the waveguide parts (4, 5) both exceed the length (L3, L4) of each one of the sealing frame's flanges (21, 22), such that the sealing frame's flanges (21, 22) may be fitted between the respective flanges (14, 16; 13, 15) of the waveguide parts (4, 5).

5. A transition arrangement according to claim 4, characterized in that the first distance (L1) and the second distance (L2) are essentially equal, and that the lengths (L3, L4) of the sealing frame's flanges (21, 22) are essentially equal.

6. A transition arrangement according to claim 1, characterized in that the sealing frame (17) is attached to the waveguide parts (4, 5) by means of solder or electrically conducting glue.

7. A transition arrangement according to claim 1, characterized in that the sealing frame (17) is made in several layers of material; an outer layer (24) being made of an electrically insulating material, a middle layer constituting a metalization layer (25), making the sealing frame electrically conductive, an inner layer comprising an electrically conducting attachment means in the form of a solder alloy (26) or electrically conducting glue.

8. A transition arrangement according to claim 1, characterized in that a first recess (27) is formed in a part of the first waveguide part (4) which is arranged to be covered by the sealing frame (17), the first recess (27) running perpendicular to the longitudinal extension of the first waveguide part (4), all the way along the three walls (7, 8, 9), where a corresponding second recess (28) is formed on the second waveguide part (5); and where, corresponding to these recesses (27, 28), lines of an electrically conducting attachment means (29, 30) are dispensed on the sides of the walls (18, 19, 20) of the sealing frame (17) that are intended to face the waveguide parts (4, 5), such that the lines of electrically conducting attachment means (29, 30) are fitted into the recesses (27, 28) when the sealing frame (17) is mounted.

9. A transition arrangement according to claim 8, characterized in that the lines (29, 30) are combined with indents in the sealing frame (17), the indents being intended to fit into the recesses (27, 28) when the sealing frame (17) is mounted.

10. A transition arrangement according to claim 8, characterized in that the electrically conducting attachment means is in the form of solder or electrically conducting glue.

11. An electrically conducting sealing frame, (17) characterized in that it is arranged to be mounted over the ends (4a, 5a) of a first surface-mountable waveguide part (4) and a second surface-mountable waveguide part (5), covering them, where the sealing frame (17) has a first wall (18), a second wall (19) and a third wall (20), where the second and third walls (19, 20) are arranged to contact a dielectric carrier material (1), all the walls together essentially forming a U-shape, and where the first waveguide part (4) comprises a first wall (7), a second wall (8) and a third wall (9), which second and third walls (8, 9) are arranged to contact the dielectric carrier material (1), all the walls (7, 8, 9) together essentially forming a U-shape, where the second waveguide part (5) comprises a first wall (10), a second wall (11) and a third wall (12), which second and third want (11, 12) are arranged to contact the dielectric carrier material (1), all the walls (10, 11, 12) together essentially forming a U-shape, where the surface-mountable waveguide parts (4, 5) are arranged to be mounted on the dielectric carrier material (1) in such a way that the surface-mounted waveguide parts (4, 5) comprise ends (4a, 5a) which are positioned to face each other.

12. A sealing frame (17) according to claim 11, characterized in that it is attached to the waveguide parts (4, 5) by means of solder or electrically conducting glue.

13. A sealing frame (17) according to claim 11, characterized in that the sealing frame (17) is made in several layers of material; an outer layer (24) being made of an electrically insulating material, a middle layer constituting a metalization layer (25), making the sealing frame electrically conductive, an inner layer comprising an electrically conducting attachment means in the form of a solder alloy (26) or electrically conducting glue.
